(19) United States
(12) Patent Application Publication
(10) Pub. No.: US 2005/0150753 A1
(43) Pub. Date: Jul. 14, 2005

(54) Key structure and manufacturing method thereof

(76) Inventor: Chih-Min Hsu, Taipei City (TW)

Correspondence Address: BIRCH STEWART KOLASCH & BIRCH, PO BOX 747, FALLS CHURCH, VA, 22040-0747, US

(21) Appl. No.: 10/921,175

(22) Filed: Aug. 19, 2004

(30) Foreign Application Priority Data
Jan. 12, 2004 (TW) 093100647

(51) Int. Cl. H01H 9/26

(52) U.S. Cl. 200/314

(57) ABSTRACT

A key structure. The key structure includes a lower cover, a keycap, and a light source. The keycap is disposed above the lower cover, and a lower surface of each keycap has at least one depression. The light source is disposed between the lower cover and the keycap. Light is emitted from the light source toward the depression and penetrates the keycap.

### BACKGROUND OF THE INVENTION

1. Field of the Invention

The present invention relates to a key structure for a keyboard and in particular to an illuminated key and a manufacturing method thereof.

2. Description of the Related Art

As mobile phones are widely used, both innovative functions and aesthetic design are seen as necessary to attract users. To stand out and apart from conventional designs, some manufacturers include a plurality of light sources such as LEDs disposed under the keypad of a cell phone. When a key is pressed, the light source is activated, illuminating the keypad. Thus, in a dark environment, the keys on the phone are visible. In the conventional mobile phone, however, the keypad is not uniformly illuminated. That is, keys disposed further away from the light source are less bright. Additionally, in order to uniformly distribute light, more light sources are necessary, resulting in increased cost and additional power consumption.

Thus, there is a need to provide a key structure that has uniform light distribution on each key without additional light source.

### SUMMARY OF THE INVENTION

Thus, an object of the invention is to provide a key structure that has uniform light distribution on each key without additional light source and manufacturing method thereof.

The present invention provides a key structure comprising a lower cover, a keycap, and a light source. The keycap is disposed above the lower cover, and a bottom of the keycap comprises at least one depression. The light source is disposed between the lower cover and the keycap. Light emitted from the light source is directed toward the depression, penetrating the keycap.

Accordingly, the depression is arc shaped.

In one embodiment, the key structure has a plurality of depressions, separately disposed on the bottom of the keycap.

The key structure further comprises an upper cover, encompassing the keycap and having a bottom surface. The bottom surface is opaque.

The key structure further comprises a rubber layer, disposed between the lower cover and the keycap, having a transparent surface, disposed corresponding to the keycap, and an opaque surface, surrounding the transparent surface.

The key structure further comprises an elastic layer, disposed between the lower cover and the keycap, having an upper surface and a plurality of hollow metal domes, disposed under each keycap. The keycap is pressed down to conduct current via the metal dome and is returned to its original position by the elasticity of the metal dome. The elastic layer of the upper surface is reflective.

Accordingly, the light source is a light emitting diode.

The present invention further provides a method for manufacturing a key structure. The method comprises the steps of forming a keycap by injection molding with at least one depression formed at a bottom thereof, providing a light source disposed above a lower cover, and positioning the keycap and the depression thereof over the light source.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view of a key structure according to the present invention;

FIG. 2 is a schematic cross section of the key structure according to the first embodiment of the present invention, wherein each keycap comprises an arc shaped depression formed on the lower surface of the keycap;

FIG. 3 is a schematic cross section of the key structure according to the second embodiment of the present invention, wherein there are a plurality of depressions disposed under each keycap and functioning as lenses to uniformly refract light over the surface of the entire keycap;

FIG. 4a is a flowchart of manufacturing method according to the first embodiment of the present invention; and

FIG. 4b is a flowchart of manufacturing method according to a variation of the first embodiment.

### DETAILED DESCRIPTION OF THE INVENTION

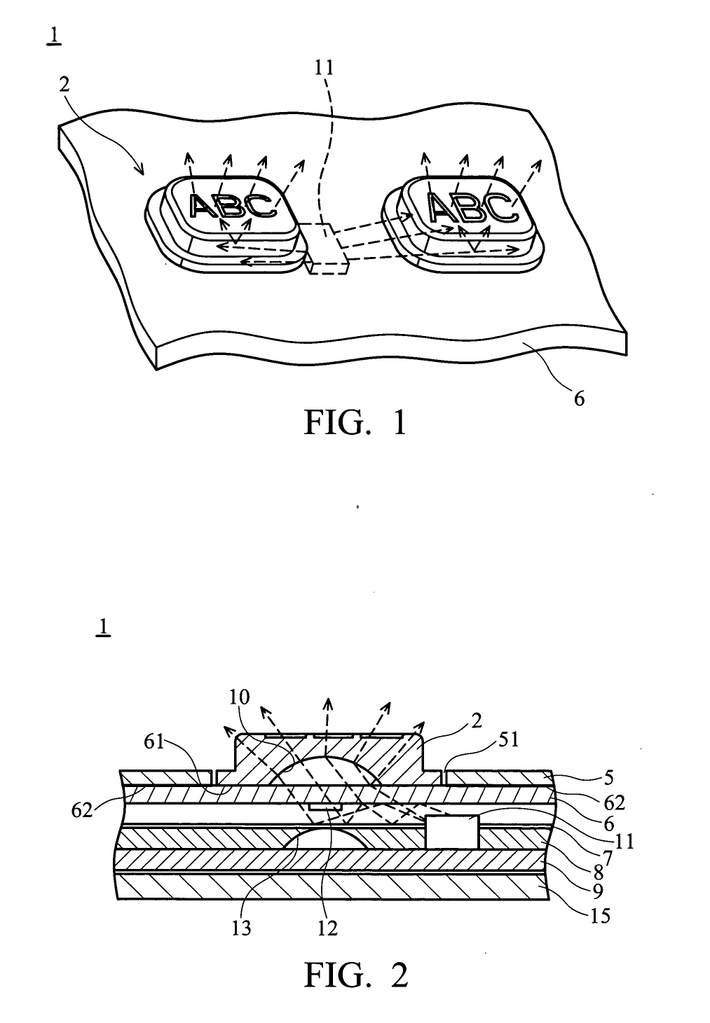

FIG. 1 is a schematic view of a key structure according to the present invention. The key structure 1 is applicable to a mobile phone. The key structure 1 comprises a plurality of keycaps 2, a light source 11 and a rubber layer 6. It should be noted that other elements of the mobile phones are omitted for simplicity, and only two of the keycaps are shown as representatives.

The visible surface of each light transmissible keycap 2 is engraved with characters or numbers thereon. The keycap 2 is disposed on the rubber layer 6. The light source 11 is disposed under the rubber layer 6 and between the keycaps 2. The light source 11 is a light emitting diode. Light is emitted to and penetrates the keycap 2, the engraved character illuminating thereon.

The following describes the first embodiment of the present invention.

### FIRST EMBODIMENT

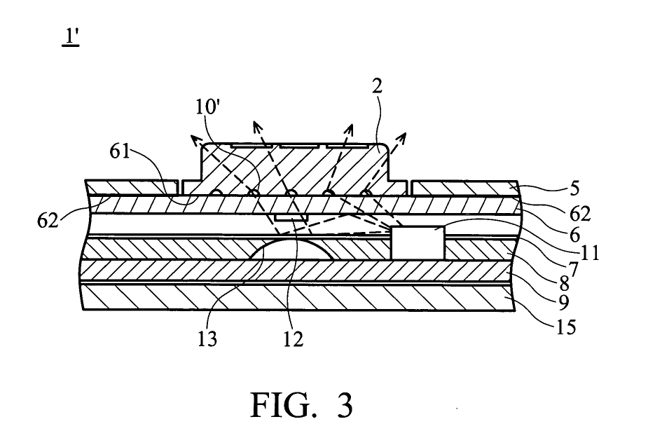

FIG. 2 is a schematic cross section of the key structure 1 according to the first embodiment of the present invention. The key structure 1 further comprises an upper cover 5, an elastic layer (PET layer) 8, a printed circuit board 9, and a lower cover 15. The body of the mobile phone comprises the upper cover 5 and lower cover 15. The upper cover 5 has a plurality of openings 51 corresponding to each keycap 2 such that after assembly, each keycap 2 passes through an opening 51 and protruded from the upper cover 5. The rubber layer 6 is disposed under the upper cover 5 and above the elastic layer 8. The printed circuit board 9 is disposed in the lower cover 15. The rubber layer 6 directly under the keycap 2 comprises a protrusion 12 facing the elastic layer 8. Moreover, a plurality of hollow metal domes 14 are disposed under the elastic layer 8. Each metal dome 14 corresponds to the bottom of the keycap 2. When the keycap 2 is pressed downward, the rubber layer 6 is deformed thereby and the protrusion 12 contacts the metal dome 14 of the elastic layer 8. As a result, the metal dome 14 activates the printed circuit board 9, producing corresponding signals. The light source 11 is electrically connected with the printed circuit board 9, providing power thereto.

The lower surface of the keycap 2 is described in the following. Each keycap 2 comprises an arc shaped depression 10 formed on the lower surface thereof. The depression 10 serves as a lens, retracting light emitted therein uniformly distributing the light to evenly illuminate the entire surface of the keycap 2.

Furthermore, to concentrate light to the keycap 2, a transparent surface 61 and an opaque surface 62 are formed on an upper surface of the rubber layer 6. The transparent surface 61 is the portion directly under the keycap 2. Namely, the portion of the upper surface of the rubber layer 6 directly under the openings 51of the upper cover 51 is a transparent surface. The opaque surface 62 surrounds the transparent surface 61. Thus, light does not penetrate the opaque surface 62, and is efficiently directed through the transparent surface 61, concentrating the light on the keycap 2.

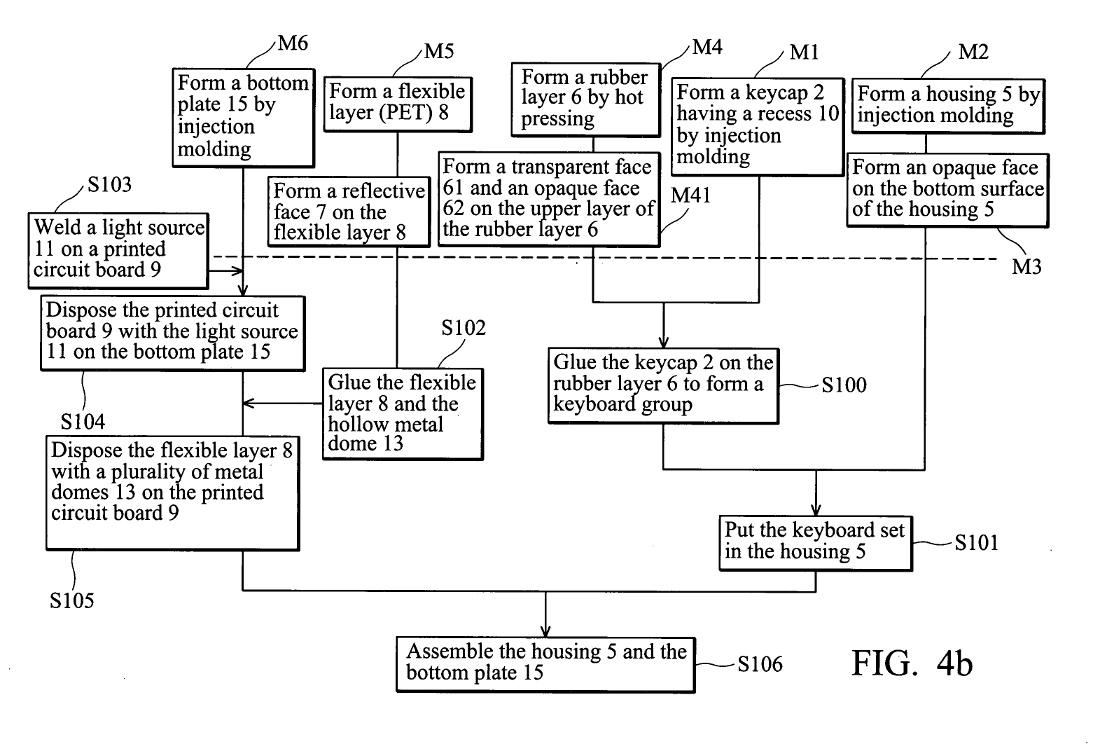

FIG. 4a is a flowchart of manufacturing method according to the first embodiment of the present invention, wherein the manufacturing steps are shown by steps M1 to M6, and the assembly steps are shown by steps S100 to S106.

The keycap 2 of the key structure 1 is formed by injection molding and a depression 10 is formed simultaneously (step M1). The depression 10 is formed as a spherical lens shape. The keycap 2 comprises a relatively hard material such as plastic.

The upper cover 5 of the mobile phone is also formed by injection molding (step M2). An opaque surface is formed on a lower surface of the upper cover 5 (step M3). Subsequently, the rubber layer 6 under the keycap 2 is formed by hot pressing (step M4). After the rubber layer 6 is formed, a transparent surface 61 and an opaque surface are formed on the upper surface of the rubber layer 6. The transparent surface 61 is located directly under the keycap 2. The opaque surface 62 surrounds the transparent surface 61.

Subsequent to formation of completion of the keycap 2, the upper cover 5, and the rubber layer 6, each keycap 2 is attached to the rubber layer 6 by glue, forming a keypad (step S100). The keypad is disposed under the upper cover 5 (step S101).

In addition, the elastic layer 8 comprising PET is formed by a shaping and punching process (step M5). The elastic layer 8 and the metal domes 13 are then integrated into one unit (step S102) by glue. The light source 11 is soldered to the printed circuit board 9 through the punched hole of the elastic layer 8 (step S103). The lower cover 15 is formed by injection molding (step M6). Next, the printed circuit board 9 is disposed on the lower cover 15 (step S104).

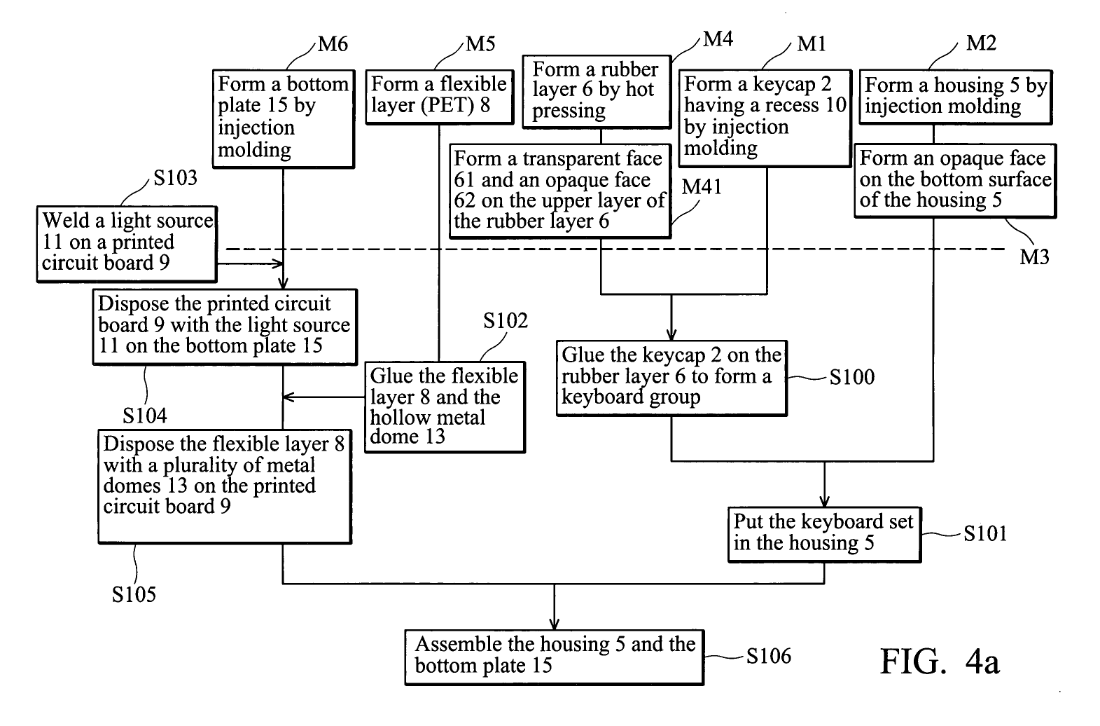

Moreover, to assemble the above elements, the elastic layer 8 and the light source 11 are disposed under the keypad, as shown in FIGS. 2 and 3. The elastic layer 8 is located above the printed circuit board 9 such that each metal dome 13 of the elastic layer 8 is located corresponding to each keycap 2. Finally, the upper and lower covers 5 and 15 are completing assembly the phone body (step S106).

In a variation of first embodiment, a reflective surface 7 (or a mirror face) is formed on the elastic layer 8 such that the light does not penetrate the elastic layer 8, but is reflected upward to the arc depression 10 by the reflective surface 7. Thus, light transmitted between the keycap 2 and the elastic layer 8 are diffused over the elastic layer 8 by the reflective surface 7 such that light transmissible range is increased and the portion beyond the light source 11 can be sufficiently illuminated. Namely, a substantially equal amount of light is distributed to each key, resulting in uniform brightness of the keypad.

FIG. 4b is a flowchart of the manufacturing method according to the variation of the first embodiment. The steps for manufacturing and assembling the key structure are substantially similar to the first embodiment. The difference is that after step M5 and before step S102, an additional step M51 is added. In step M51, the reflective surface 7 is formed on the elastic layer 8 such that the light from the light source 11 is reflected upward to the keycap 2, increasing the light transmissible range, and maintaining uniform brightness.

### SECOND EMBODIMENT

FIG. 3 is a schematic cross section of the key structure 1′ according to the second embodiment of the present invention. The key structure 1′ comprises an upper cover 5, a keycap 2, a rubber layer 6, an elastic layer 8 (thin PET layer), a printed circuit board 9, a light source 11, and a lower cover 15. The main difference between this and the first embodiment is that a plurality of depressions 10′ are disposed under each keycap 2. The descriptions of the elements common to the first embodiment are omitted in the following description.

Due to the design of the smaller depressions 10′ disposed under one keycap 2, the depressions 10′ function as lenses. After light enters the lenses, the light path is refracted to uniformly distribute light over the surface of the entire keycap 2. Thus, each keycap 2 is uniformly illuminated.

Similarly, the rubber layer 6 comprises a transparent surface 61 and an opaque surface 62. The surface of the rubber layer 6 directly under the openings 51 of the upper cover 5 is transparent, and the remainder is opaque. Thus, light is concentrated to the keycap 2. Furthermore, the lower surface of the upper cover 5 may be opaque such that light is only emitted through the keycap 2.

The flowchart of the method for manufacturing and assembling the key structure 1′ according to the second embodiment is shown in FIG. 4a. The method is substantially similar to the first embodiment, and further description is omitted in the following description. Note that in step M2, during injection molding the keycap 2, the lower surface thereof is formed with a plurality of depressions 10′ instead of only one depression, thereby achieving uniform light distribution.

In a variation of the second embodiment, substantially similar to the variation of the first embodiment, a reflective surface 7 (or a mirror) is formed on the elastic layer 8 such that the light does not penetrate the elastic layer 8 toward the printed circuit board 9. Namely, the light is reflected by the reflective surface 7 toward the arc depressions 10′ to enhance brightness and uniformly distribute light.

The flowchart of the variation of the second embodiment is also shown in FIG. 4b. After step M5, the reflective surface 7 is added to the elastic layer 8.

The advantage of the present invention is that light enters the depressions 10 or 10′ at the bottom of the keycap 2 and is refracted and evenly distributed under the keycap 2. Thus, the present invention does not require additional light sources to achieve uniform light distribution. Furthermore, since there is a reflective surface 7 disposed on the elastic layer 8, the light is first reflected between the keycap 2 and the elastic layer 8, and then transmitted to the keycap 2. Thus, the light distribution range is wider and the portion beyond the light source 11 also receives sufficient light. Thus, the present invention provides uniform brightness over the entire key structure.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A key structure comprising:
a lower cover;
a keycap having a lower surface, disposed above the lower cover, wherein the lower surface of the keycap comprises at least one depression; and
a light source, disposed between the lower cover and the keycap, wherein light is emitted from the light source toward the depression and penetrates the keycap.

2. The key structure as claimed in claim 1, wherein the depression is an arc shaped.

3. The key structure as claimed in claim 1, further comprising a plurality of depressions, disposed under the keycap.

4. The key structure as claimed in claim 1, further comprising an upper cover, encompassing the keycap and the lower surface, wherein the lower surface is opaque.

5. The key structure as claimed in claim 1, further comprising a rubber layer, disposed between the lower cover and the keycap, having a transparent surface, disposed corresponding to the keycap, and an opaque surface, surrounding the transparent surface.

6. The key structure as claimed in claim 1, further comprising an elastic layer, disposed between the lower cover and the keycap, having an upper surface and a plurality of hollow metal domes, disposed under each keycap; wherein when the keycap is pressed downward, current is conducted via the metal domes and the keypad is returned to its original position by the elasticity of the metal domes; wherein the elastic layer of the upper surface is a reflective surface.

7. The key structure as claimed in claim 1, wherein the light source is a light emitting diode.

8. A method for manufacturing a key structure, the method comprising the steps of:
forming a keycap by injection molding with at least one depression formed in the lower surface thereof;
providing a light source disposed above a lower cover; and
positioning the keycap above the light source and the depression of the keycap over the light source.

9. The method as claimed in claim 8, wherein the at least one depression is arc shaped.

10. The method as claimed in claim 8, further comprising the following steps of:
forming a rubber layer by hot pressing;
forming a transparent surface and an opaque surface on an upper surface of the rubber layer; and
positioning the rubber layer between the lower cover and the keycap, arranging the transparent surface directly underneath the keycap such that the transparent surface is facing the keycap.

11. The method as claimed in claim 8, further comprising the following steps of:
forming an elastic layer by pressing;
forming a reflective surface on an upper surface of the elastic layer; and
engaging a plurality of hollow metal domes with the elastic layer; and
positioning each metal dome corresponding to and under each keycap.

12. The method as claimed in claim 8, wherein the light source is a light emitting diode, disposed on the lower cover by soldering.
